(19) United States
(12) Patent Application Publication
(10) Pub. No.: US 2026/0119646 A1
(43) Pub. Date: Apr. 30, 2026

(54) GENERATING SYNTHETIC SIGNALS BY A SECURITY ANALYTICS PLATFORM

(71) Applicant: Google LLC, Mountain View, CA (US)

(72) Inventors: Michele Spagnuolo, Zürich (CH); Artur Janc, Zürich (CH); Lukas Weichselbaum, Gattikon (CH)

(21) Appl. No.: 18/929,401

(22) Filed: Oct. 28, 2024

(51) Int. Cl. G06F 21/55

(52) U.S. Cl. CPC G06F 21/552; G06F 2221/034

(57) ABSTRACT

A response to a request initiated by a client is received by a processing device of a reverse proxy from an application of a plurality of applications associated with a specified entity. A header of a predefined type is identified within the response. One or more metadata items characterizing one or more security features of the application are retrieved from the header. An updated response is produced by removing the header from the response. The updated response is forwarded to the client. One or more synthetic signals characterizing security properties of the application is generated based on the one or more metadata items. The one or more synthetic signals is stored in a memory of a security analytics platform.

### TECHNICAL FIELD

Aspects and embodiments of the disclosure relate to web security, and more specifically, to systems and methods for generating synthetic signals by a security analytics platform.

### BACKGROUND

In today's digital age, organizations are constantly facing an increasing volume of sophisticated cybersecurity threats. Cybersecurity is the practice of protecting systems, networks, and data from digital attacks, unauthorized access, and damage. Traditional cybersecurity measures are often inadequate in providing comprehensive protection against such threats, which has resulted in the proliferation of large numbers of disparate cybersecurity operations tools such as Security Orchestration, Automation, and Response (SOAR) platforms, Security Information and Event Management (SIEM) systems, Intrusion Detection Systems (IDS), Intrusion Prevention Systems (IPS), antivirus software, endpoint protection, vulnerability management tools, and more. These platforms and systems can generate multiple alerts for each detection of a security threat. Because not all security threats are of equal importance, it can be challenging to sift through a large quantity of security threats. Analyzing and acting upon the staggering volume of security threats generated by such an ever-increasing number of cybersecurity operations tools is complex and cumbersome, leading to inefficiencies and vulnerabilities.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method may include: receiving, by a processing device of a reverse proxy, a response to a request initiated by a client; identifying, within the response, a header of a predefined type; retrieving, from the header, one or more metadata items characterizing one or more security features of an application; producing an updated response by removing the header from the response; forwarding the updated response to the client; generating, based on the one or more metadata items, one or more synthetic signals characterizing security properties of the application; and storing the one or more synthetic signals in a memory of a security analytics platform. The response to the request initiated by the client may be received from the application of a plurality of applications associated with a specified entity.

In one implementation, the method may further include storing, in the memory, at least part of the response in association with the one or more synthetic signals.

In one implementation, the method may further include receiving log data from a plurality of computing systems associated with the specified entity and producing, based on the one or more synthetic signals and the log data, a security outcome associated with the specified entity.

In one implementation, the predefined type may identify a custom header produced by an instrumented framework of the application.

In one implementation, a first synthetic signal of the one or more synthetic signals may identify a templating system utilized by the application for generating the response.

In one implementation, a first synthetic signal of the one or more synthetic signals may identify a verification procedure performed by the application for generating the response.

In one implementation, a first synthetic signal of the one or more synthetic signals may identify a security property of the application.

In an aspect of the disclosure, a system includes a memory device that stores instructions, and a processing device operatively coupled to the memory device that executes the instructions to perform operations according to any aspect or implementation described herein. In an aspect of the disclosure, a system includes a processor-readable memory and a processing device operatively coupled to the processor-readable memory. The processor-readable memory, which may be a non-transitory memory although this aspect is not limited to this, stores instructions that, when executed by the processing device, cause the processing device to perform a method according to any aspect of implementation described herein.

In an aspect of the disclosure, a non-transitory machine-readable storage medium stores instructions that, responsive to execution by a processing device, cause the processing device to perform operations according to any aspect or implementation described herein.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIG. 1 is a block diagram illustrating an example system architecture, in accordance with an implementation of the disclosure.

FIG. 2 is a flow diagram illustrating an example method of generating synthetic signals by a security analytics platform, in accordance with an implementation of the disclosure.

FIG. 3 is a block diagram illustrating one implementation of a computer system, in accordance with an implementation of the disclosure.

### DETAILED DESCRIPTION

Aspects and implementations of the disclosure are directed to generating synthetic signals by a security analytics platform. The security analytics platform can serve one or more clients (e.g., represented by entities such as organizations). The security analytics platform can provide a client organization with tools to manage computer and network security for the client.

The security analytics platform can be part of an online (e.g., virtual) platform that provides clients with a comprehensive suite of productivity tools, programs, and services. The security analytics platform can combine the features of a SIEM and a SOAR into a unified platform. The security analytics platform collects logs from a client and provides the client with tools to detect, analyze, and respond to incidents described in the collected logs. One or more features of the security analytics platform can be automated or partially automated, including log collection actions, incident detection actions, data analysis actions, or incident response actions.

The client organization can provide security data (e.g., ingested data) to the security analytics platform. As used herein, security data can include telemetry data such as log files produced by the operating systems, middleware, and/or applications that reflect actions which occurred at specific moments in time on a computing resource. Once the security analytics platform receives the ingested data from the client organization, the client organization can use the tools or services of the security analytics platform to perform security actions with the ingested data. The security actions of the security analytics platform can generate one or more of events, detections, or alerts from the ingested data. Some security analytics platforms can provide notifications based on the events, detections or alerts that are generated.

An organization may use a reverse proxy for providing load balancing, terminating HyperText Transfer Protocol Secure (HTTPS) traffic, or providing centralized logging and related capabilities for one or more applications.

In some implementations, the reverse proxy may generate traffic logs. A traffic log may include one or more records that capture details of requests and responses passing via the reverse proxy. A traffic log record may include timestamps, Internet protocol (IP) addresses, and/or uniform resource locators (URLs) accessed. A traffic log record may also include at least portions of HyperText Transfer Protocol (HTTP) headers of requests and responses that flow through the reverse proxy. An HTTP header may include one or more key-value pairs carrying certain metadata associated with the request or response, such as content type, authorization, and/or cookies.

While HTTP headers may provide certain metadata characterizing security features of an application, such metadata may not be sufficient for evaluating the security profile of an application, not to mention the security posture of the organization, since certain security properties of an application may not be reflected by the metadata carried by HTTP headers.

Furthermore, an application may interact with a wide variety of backend components (e.g., transmitting data and invoking capabilities with Remote Procedure Calls, calling software libraries written in different languages, using databases or other data storage systems for persistence, etc.), which may be controlled by a set of parameters, the values of which would only be known at the runtime. Such a highly distributed and dynamic nature of applications may hinder the analysis of internal states or security properties of various executable modules that are invoked by these applications.

Aspects of the present disclosure address the above-noted and other challenges by implementing a framework that allows an application to expose these security properties at runtime, through custom HTTP headers carrying synthetic signals. Each synthetic signal may reflect a corresponding security property or a combination of security properties of the application. “Application” broadly refers to any executable code, such as, e.g., a web application, a middleware component, an operating system component, etc. “Security property” broadly refers to one or more security-related features and/or attributes of an application (e.g., the presence or absence of a certain library, usage of a certain technique, etc.).

The values that are extracted from custom HTTP header security signals may be utilized by a reverse proxy operating within an enterprise network for generating synthetic security signals (e.g., synthetic signals). Each synthetic signal may be generated based on the values of one or more custom HTTP headers and/or other relevant metadata. A custom HTTP header may be produced, e.g., by an instrumented framework of the application.

Upon generating the synthetic signals, the reverse proxy may forward them, in association with the application identifier and other relevant metadata (e.g., the source and destination network addresses and/or ports of one or more network packets carrying the response), to the security analytics platform. In an illustrative example, a synthetic signal may identify a templating system utilized by the web application for generating the response. In another illustrative example, a synthetic signal may identify a verification procedure performed by the web application for generating the response. In another illustrative example, a synthetic signal may identify a security property of the web application.

The security analytics platform may utilize various combinations of the synthetic signals and other security data (e.g., log data generated by one or more applications, middleware, and/or operating systems) for generating various security outcomes, such as events, detections, alerts, corrective actions, etc.

The proxy server may remove the custom HTTP headers before forwarding the HTTP response to the client, thus preventing internal security-relevant information from being exposed to end users.

Thus, implementations of the present disclosure may facilitate generation, exposure, collection, and usage of security-related metadata which may efficiently characterize security profiles of one or more applications and/or security posture of the organization.

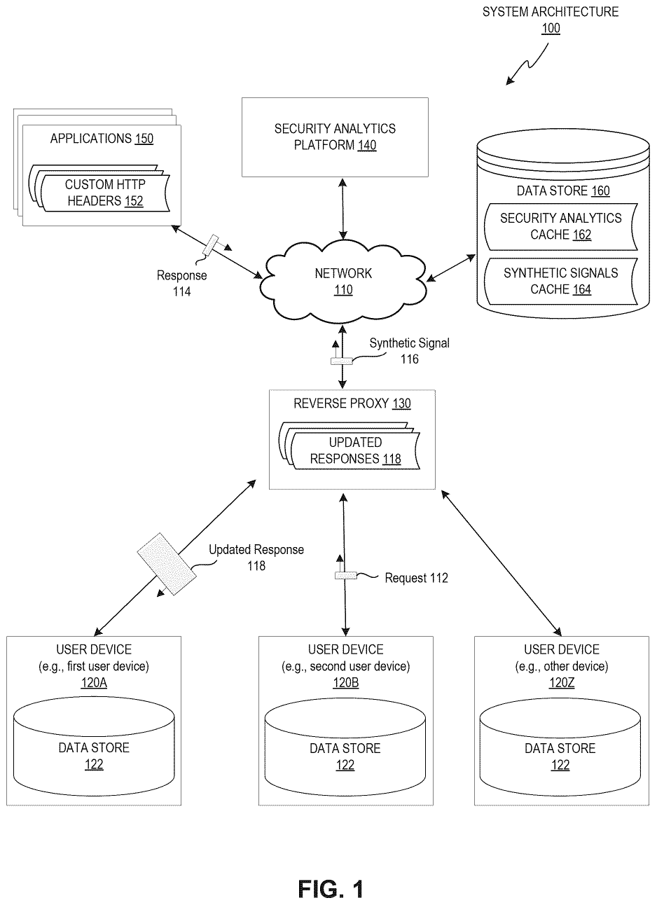

FIG. 1 is a block diagram illustrating an example system architecture 100, in accordance with an implementation of the disclosure. The system architecture includes a network 110, user devices 120A-Z, reverse proxy 130, security analytics platform 140, one or more applications 150, and a data store 160.

Network 110 may be a public network that provides one or more of user devices 120A-Z with access to security analytics platform 140, web applications 160, and other publicly available computing devices. Network 110 may include one or more wide area networks (WANs), local area networks (LANs), wired networks (e.g., Ethernet network), wireless networks (e.g., an 802.11 network or a wireless local area network (WLAN)), cellular networks (e.g., a Long Term Evolution (LTE) network), routers, hubs, switches, server computers, and/or a combination thereof.

User devices 120A-Z may each include computing devices such as personal computers (PCs), laptops, mobile phones, smart phones, tablet computers, netbook computers, network-connected televisions, etc. User devices 120A-Z may be capable of accessing the one or more applications 150. In some implementations, the one or more applications 150 may broadly refer to any executable code, such as a web application, a middleware component, an operating system component, etc. User devices 120A-Z may also be capable of sending a request 112 and receiving an associated updated response 118 from the one or more applications 150 via the reverse proxy 130. These will be discussed in more detail below.

The reverse proxy 130 may intercept (e.g., capture) a response 114 sent from the one or more applications 150 in response to the request 112 sent from user devices 120A-Z. The response 114 may include one or more custom HTTP headers 152 (e.g., custom header), which may be utilized for generating a synthetic signal 116. In some implementations, the one or more applications 150 may utilize an instrumented framework (e.g., a web framework or structure that has been enhanced with additional monitoring and data collection tools to track the web application's performance, detect issues, and gather insights on user interactions) to produce the one or more custom HTTP headers 152. In some implementations, the one or more custom HTTP headers 152 may capture various security related parameters associated with security properties (e.g., the presence or absence of a certain library, usage of a certain technique, a build version, a programming language, etc.) In some implementations, the reverse proxy 130 may extract values (e.g., metadata) from the one or more custom HTTP headers 152 to generate the synthetic signal 116.

In some implementations, the synthetic signal 116 may be used to identify a templating system utilized by the one or more applications 150 for generating the response 114. In some implementations, the synthetic signal 116 may be used to identify a verification procedure performed by the one or more applications 150 for generating the response 114. In some implementations, the synthetic signal 116 may be used to identify a security property of the one or more applications 150. In some implementations, a security property may broadly refer to one or more security-related features and/or attributes of the one or more applications 150. For example, a security property may refer to the presence or absence of a certain library, usage of a certain technique, a build version, a programming language, a framework of the one or more applications 150, information about the specific server-side code responsible for creating the response 114, etc. In some implementations, the synthetic signal 116 may be used to identify one or more web security features of the one or more applications 150, such as a content security policy, a security mechanism (e.g., the Trusted Types security feature), a context-aware security header (e.g., the Fetch Metadata security feature), or the like.

The reverse proxy 130 may remove the one or more custom HTTP headers 152 from the response 114, creating an updated response 118 to be forwarded to user devices 120A-Z. The reverse proxy 130 may provide the synthetic signal 116 generated from the one or more custom HTTP headers 152 in combination with other relevant metadata from the response 114 to the security analytics platform 140.

The reverse proxy 130 may create a traffic log containing the synthetic signal 116. In some implementations, the traffic log may associate the synthetic signal 116 with the one or more applications 150 (e.g., via an application identifier) and other relevant metadata (e.g., the source and destination network addresses and/or ports of one or more network packets carrying the response 114). The reverse proxy 130 may provide the traffic log containing the synthetic signal 116 to the security analytics platform 140.

Security analytics platform 140 may receive the traffic log from the reverse proxy 130. The traffic log may include a variety of security data, including the one or more custom HTTP headers 152 and/or synthetic signal 116. The security analytics platform 140 may interpret and parse the synthetic signal 116 generated by the reverse proxy 130 based on the one or more custom HTTP headers 152. The security analytics platform 140 may parse the data contained in the traffic log to identify various metadata characterizing one or more security features of an application. In some implementations, the metadata characterizing one or more security features may include metadata related to the production environment, ownership, and/or source code associated with the one or more applications 150.

In some implementations, the security analytics platform 140 may interpret the synthetic signal 116 in accordance with a description unique to each type of synthetic signal 116. For example, if the synthetic signal 116 corresponds to a synthetic signal type of “RESPONSE_TYPE”, the security analytics platform 140 may interpret the synthetic signal 116 based on the “RESPONSE_TYPE” type to expose the use of type-safe responses and autoescaping (e.g., the automatic conversion of special characters into representations that prevent them from being interpreted as code) hypertext markup language (HTML) templating systems for cross-site scripting (XSS) prevention. As another example, in some implementations, if the synthetic signal 116 corresponds to a synthetic signal type of “TEMPLATE”, the security analytics platform 140 may interpret the synthetic signal 116 based on the “TEMPLATE” type to expose the server-side templating system that generates the HTML output.

In some implementations, the security analytics platform 140 may utilize various combinations of the synthetic signal 116 and other security data (e.g., log data generated by the one or more applications 150, middleware, and/or operating systems) for generating various security outcomes, such as events, detections, alerts, corrective actions, etc. In some implementations, the generated security outcomes may be utilized by the security analytics platform 140 and/or stored in data store 160.

Data store 160 may include a security analytics cache 162 that stores one or more of instructions that are to be transmitted to security analytics platform 140. Data store 160 may include a synthetic signals cache 164 that stores instructions that are to be transmitted to security analytics platform 140.

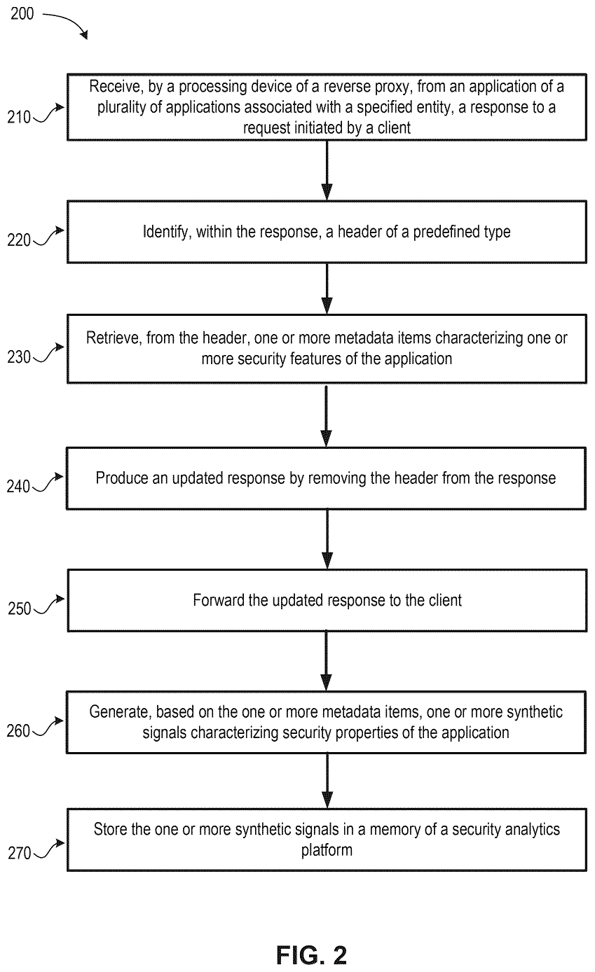

FIG. 2 depicts a flow diagram for illustrative examples of method 200 for generating synthetic signals by a security analytics platform. Method 200 and/or each of the aforementioned method's individual functions, routines, subroutines, or operations may be performed by a processing device, having one or more processing units (CPU) and memory devices communicatively coupled to the CPU(s). In some implementations, the aforementioned method may be performed by a single processing thread or alternatively by two or more processing threads, each thread executing one or more individual functions, routines, subroutines, or operations of the method. The aforementioned method as described below may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, method 200 may be performed by reverse proxy 130 and security analytic platform 140 described in FIG. 1. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows may be possible. In some implementations, the same, different, fewer, or greater operations may be performed. It may be noted that elements of FIG. 1 may be used herein to help describe FIG. 2.

FIG. 2 is a flow diagram illustrating an example method of generating synthetic signals by a security analytics platform, in accordance with an implementation of the disclosure.

At operation 210, a processing device of a reverse proxy may receive a response to a request initiated by a client. In some implementations, the response is from an application of a plurality of applications associated with a specified entity (e.g., an organization, business, or individual that owns, operates, or has a stake in the web application).

At operation 220, the processing device of the reverse proxy may identify, within the response, a header of a predefined type. In some implementations, the predefined type may identify a custom HTTP header produced by an instrumented framework of the application.

At operation 230, the processing device of the reverse proxy may retrieve, from the header, one or more metadata items characterizing one or more security features of the application. In some implementations, a security analytics platform (e.g., the security analytics platform 140 of FIG. 1) may retrieve the one or more metadata items. In some implementations, the security analytics platform may receive log data from a plurality of computing systems associated with the specified entity. In some implementations, the security analytics platform may produce a security outcome associated with the specified entity based on the one or more metadata items and the log data.

At operation 240, the processing device of the reverse proxy may produce an updated response by removing the header from the response.

At operation 250, the processing device of the reverse proxy may forward the updated response to the client.

At operation 260, the processing device of the reverse proxy may generate, based on the one or more metadata items, one or more synthetic signals characterizing security properties of the application. In some implementations, a first synthetic signal of the one or more synthetic signals may identify a verification procedure performed by the web application for generating the response. In some implementations, a first synthetic signal of the one or more synthetic signals may identify a security property of the web application.

At operation 270, a processing device of the reverse proxy may store the one or more synthetic signals in a memory of a security analytics platform. In some implementations, a processing device of the reverse proxy may store, in the memory, at least part of the response in association with the one or more synthetic signals. In some implementations, the at least part of the response may be created through cardinality reduction (e.g., the process of reducing the number of unique values in a dataset's categorical feature to simplify analysis and improve model performance). Cardinality reduction may reduce a high-cardinality input that is impractical to query (e.g., traffic logs with hundreds of billions of distinct entries) to a lower-cardinality output designed to be easy to query and search. In some implementations, cardinality reduction may be accomplished through path reduction (e.g., simplifying URL paths by eliminating redundant or superfluous paths or information) and/or user-agent parsing (e.g., parse user information to keep only course-grained information, such as web browser name and version). In some implementations, cardinality reduction may help ensure that the output data is fully anonymous by removing any personalized data from the input.

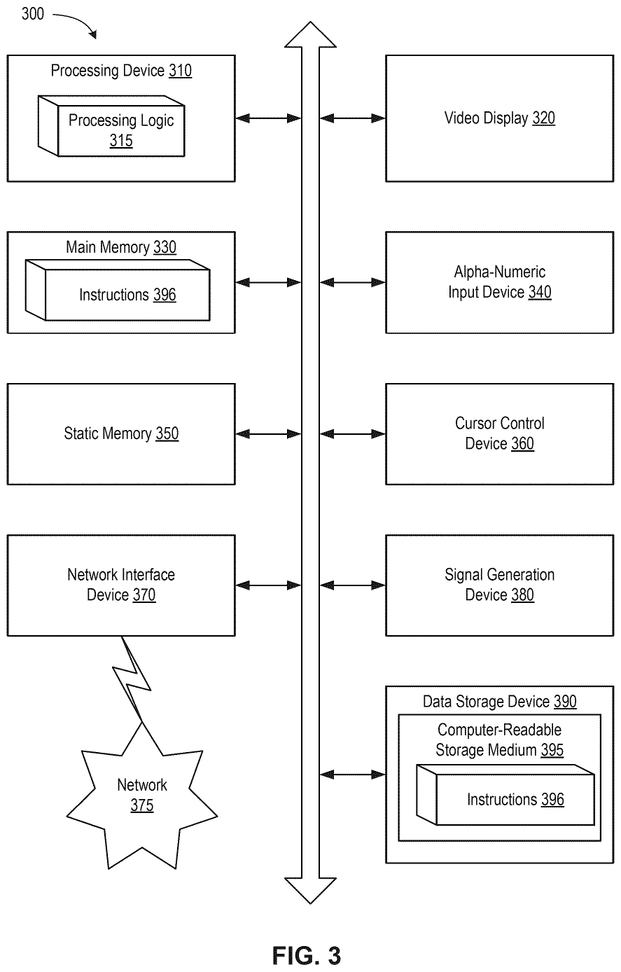

FIG. 3 is a block diagram illustrating one implementation of a computer system 300, in accordance with an implementation of the disclosure. In certain implementations, the computer system 300 executes one or more sets of instructions that cause the computer to perform any one or more of the methodologies discussed herein. Set of instructions, instructions, and the like may refer to instructions that, when executed by computer system 300, cause computer system 300 to perform one or more operations of system architecture 100. The computer may operate in the capacity of a server of a client device in a client-server network environment, or as a peer machine in a peer-to-peer (or distributed) network environment. The computer may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that computer. Further, while only a single computer is illustrated, the term “computer” shall also be taken to include any collection of computers that individually or jointly execute the sets of instructions to perform any one or more of the methodologies discussed herein.

In a further aspect, the computer system 300 may include a processing device 310, a main memory 330 (e.g., read-only memory (ROM), flash memory, dynamic random access memory (DRAM) such as synchronous DRAM (SDRAM) or Rambus DRAM (RDRAM), etc.), a static memory 350 (e.g., flash memory, static random access memory (SRAM), etc.), and a data storage device 390, which communicate with each other via a bus.

The processing device 310 may represent one or more general purpose processing devices such as a microprocessor, central processing unit, or the like. More particularly, the processing device 310 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 310 may also be one or more special-purpose processing devices such as an application specific integrated circuit (ASIC), a field programmable gate array (FPGA), a digital signal processor (DSP), network processor, or the like. The processing device 310 may include processing logic 315 configured to execute instructions of the system architecture 100 for performing the operations discussed herein.

The computer system 300 may further include a network interface device 370 that may provide communication with other computers over a network 375, such as a local area network (LAN), an intranet, an extranet, or the Internet. The computer system 300 may also include a video display 320 (e.g., a liquid crystal display (LCD) or cathode ray tube (CRT)), an alpha-numeric input device 340 (e.g., a keyboard), a cursor control device 360 (e.g., a mouse), and a signal generation device 380 (e.g., a speaker).

The data storage device 390 may include a non-transitory computer-readable storage medium 3595 on which may be stored the sets of instructions 396 of the system architecture 100 implementing any one or more of the methodologies or functions described herein. The sets of instructions 396 of the system architecture 100 may also reside, completely or at least partially, within the main memory 330 and/or within the processing device 310 during execution thereof by the computer system 300, the main memory 330, and the processing device 310 also constituting computer-readable storage media. The sets of instructions 396 may further be transmitted or received over the network 375 via the network interface device 370.

While computer-readable storage medium 395 is shown in the illustrative examples as a single medium, the term “computer-readable storage medium” may include a single medium or multiple media (e.g., a centralized or distributed database, and/or associated caches and servers) that store the sets of instructions 396. The term “computer-readable storage medium” may include any medium that is capable of storing, encoding, or carrying a set of instructions 396 for execution by the computer and that causes the computer to perform any one or more of the methodologies of the disclosure. The term “computer-readable storage medium” may include, but not be limited to, solid-state memories, optical media, and magnetic media.

The methods, components, and features described herein may be implemented by discrete hardware components or may be integrated in the functionality of other hardware components such as ASICs, FPGAs, DSPs, or similar devices. In addition, the methods, components, and features may be implemented by firmware modules or functional circuitry within hardware devices. Further, the methods, components, and features may be implemented in any combination of hardware devices and computer program components, or in computer programs.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Unless specifically stated otherwise, it is appreciated that throughout the description, discussions utilizing terms such as “receiving”, “identifying”, “retrieving”, “producing”, “forwarding”, “generating”, “storing” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional implementations, one or more processing devices for performing the operations of the above described embodiments are disclosed. Additionally, in implementations of the disclosure, a non-transitory computer-readable storage medium stores instructions for performing the operations of the described implementations. Also in other implementations, systems for performing the operations of the described implementations are also disclosed.

It is to be understood that the above description is intended to be illustrative, and not restrictive. Other implementations will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
receiving, by a processing device of a reverse proxy, from an application of a plurality of applications associated with a specified entity, a response to a request initiated by a client;
identifying, within the response, a header of a predefined type;
retrieving, from the header, one or more metadata items characterizing one or more security features of the application;
producing an updated response by removing the header from the response;
forwarding the updated response to the client;
generating, based on the one or more metadata items, one or more synthetic signals characterizing security properties of the application; and
storing the one or more synthetic signals in a memory of a security analytics platform.

2. The method of claim 1, further comprising storing, in the memory, at least part of the response in association with the one or more synthetic signals.

3. The method of claim 1, further comprising:
receiving log data from a plurality of a computing systems associated with the specified entity; and
producing, based on the one or more synthetic signals and the log data, a security outcome associated with the specified entity.

4. The method of claim 1, wherein the predefined type identifies a custom header produced by an instrumented framework of the application.

5. The method of claim 1, wherein a first synthetic signal of the one or more synthetic signals identifies a templating system utilized by the application for generating the response.

6. The method of claim 1, wherein a first synthetic signal of the one or more synthetic signals identifies a verification procedure performed by the application for generating the response.

7. The method of claim 1, wherein a first synthetic signal of the one or more synthetic signals identifies a security property of the application.

8. A system, comprising:
a memory device that stores instructions; and
a processing device, operatively coupled to the memory device that executes the instructions to perform operations comprising:
receiving, by the processing device of a reverse proxy, from an application of a plurality of applications associated with a specified entity, a response to a request initiated by a client;
identifying, within the response, a header of a predefined type;
retrieving, from the header, one or more metadata items characterizing one or more security features of the application;
producing an updated response by removing the header from the response;
forwarding the updated response to the client;
generating, based on the one or more metadata items, one or more synthetic signals characterizing security properties of the application; and
storing the one or more synthetic signals in a memory of a security analytics platform.

9. The system of claim 8, the instructions to perform operations further comprising storing, in the memory, at least part of the response in association with the one or more synthetic signals.

10. The system of claim 8, the instructions to perform operations further comprising:
receiving log data from a plurality of a computing systems associated with the specified entity; and
producing, based on the one or more synthetic signals and the log data, a security outcome associated with the specified entity.

11. The system of claim 8, wherein the predefined type identifies a custom header produced by an instrumented framework of the application.

12. The system of claim 8, wherein a first synthetic signal of the one or more synthetic signals identifies a templating system utilized by the application for generating the response.

13. The system of claim 8, wherein a first synthetic signal of the one or more synthetic signals identifies a verification procedure performed by the application for generating the response.

14. The system of claim 8, wherein a first synthetic signal of the one or more synthetic signals identifies a security property of the application.

15. A non-transitory computer-readable storage medium comprising instructions that, responsive to execution by a processing device, cause the processing device to perform operations comprising:
receiving, by the processing device of a reverse proxy, from an application of a plurality of applications associated with a specified entity, a response to a request initiated by a client;
identifying, within the response, a header of a predefined type;
retrieving, from the header, one or more metadata items characterizing one or more security features of the application;
producing an updated response by removing the header from the response;
forwarding the updated response to the client;
generating, based on the one or more metadata items, one or more synthetic signals characterizing security properties of the application; and
storing the one or more synthetic signals in a memory of a security analytics platform.

16. The non-transitory computer-readable storage medium of claim 15, the operations further comprising storing, in the memory, at least part of the response in association with the one or more synthetic signals.

17. The non-transitory computer-readable storage medium of claim 15, the operations further comprising:
receiving log data from a plurality of a computing systems associated with the specified entity; and
producing, based on the one or more synthetic signals and the log data, a security outcome associated with the specified entity.

18. The non-transitory computer-readable storage medium of claim 15, wherein the predefined type identifies a custom header produced by an instrumented framework of the application.

19. The non-transitory computer-readable storage medium of claim 15, wherein a first synthetic signal of the one or more synthetic signals identifies a templating system utilized by the application for generating the response.

20. The non-transitory computer-readable storage medium of claim 15, wherein a first synthetic signal of the one or more synthetic signals identifies a verification procedure performed by the application for generating the response.
